(19) United States
(12) Patent Application Publication
(10) Pub. No.: US 2024/0273750 A1
(43) Pub. Date: Aug. 15, 2024

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Hiroto HAMADA, Miyoshi-shi (JP); Miki TSUJINO, Nagakute-shi (JP); Masashi HATANAKA, Toyota-shi (JP); Makoto KONISHI, Nisshin-shi (JP)

(73) Assignee: TOYOTA JIDOSHA KABUSHIKI KAISHA, Toyota-shi (JP)

(21) Appl. No.: 18/428,057

(22) Filed: Jan. 31, 2024

(30) Foreign Application Priority Data
Feb. 13, 2023 (JP) 2023-020281

(51) Int. Cl. G06T 7/70; B60K 35/21; B60K 35/28; G06T 11/00; G06V 20/58

(52) U.S. Cl. CPC G06T 7/70; B60K 35/21; B60K 35/28; G06T 11/00; G06V 20/58; B60K 2360/16; B60K 2360/191; B60K 2360/21; G06T 2207/30252

(57) ABSTRACT

An information processing device includes one or more processors configured to, when an object present in a direction of travel of a vehicle traveling on a road is detected, and a positional relation between the vehicle and the object is in a predetermined state, in a road image depicting the road that is displayed on a display inside the vehicle, display an object image depicting the object at a position that reflects an actual position of the object.

### CROSS-REFERENCE TO RELATED APPLICATION

This application claims priority to Japanese Patent Application No. 2023-020281 filed on Feb. 13, 2023, incorporated herein by reference in its entirety.

### BACKGROUND

### 1. Technical Field

The present disclosure relates to an information processing device, an information processing method, and a non-transitory storage medium.

### 2. Description of Related Art

WO2020/031912 discloses technology that enables an occupant to clearly see objects that are present outside of a vehicle.

### SUMMARY

The technology of WO2020/031912 displays object-related information indicating objects on a head-up display (HUD), but there is room for improvement regarding display content of an in-vehicle display for enabling the occupant to comprehend objects that are present outside of the vehicle.

Accordingly, the present disclosure provides an information processing device, an information processing method, and a non-transitory storage medium that enable an occupant to comprehend positions of objects relative to a road on which a vehicle is traveling, by viewing an in-vehicle display.

An information processing device according to a first aspect of the present disclosure includes one or more processors configured to, when an object present in a direction of travel of a vehicle traveling on a road is detected, and a positional relation between the vehicle and the object is in a predetermined state, in a road image depicting the road that is displayed on a display inside the vehicle, display an object image depicting the object at a position that reflects an actual position of the object.

In the information processing device according to the first aspect of the present disclosure, when the object is detected by a detection unit, and the positional relation between the vehicle and the object is in a predetermined state, a control unit causes the object image to be displayed in the road image at a position that reflects the actual position of the object. Accordingly, in the information processing device, the object image is displayed at a position that reflects the actual position of the object in the road image, so that by viewing a display unit, an occupant can comprehend the position of the object relative to the road on which the vehicle is traveling.

In the information processing device according to the above aspect, the one or more processors may be configured to change the position of the object image, according to change in the actual position of the object.

In the information processing device according to the above aspect, the control unit changes the position of the object image according to change in the actual position of the object. Accordingly, in the information processing device, the occupant can comprehend change in the actual position of the object by viewing the display unit.

In the information processing device according to the above aspect, the one or more processors may be configured to change contents of the object image depending on whether the actual position of the object is outside of the road or in the road.

In the information processing device according to the above aspect, the control unit changes the contents of the object image depending on whether the actual position of the object is outside the road or in the road. Thus, in the information processing device, the degree of attention of the occupant to the object image can be raised as compared to when the contents of the object image do not change.

In the information processing device according to the above aspect, the one or more processors may be configured to display the object image in an more emphasized way when the actual position of the object is in the road, as compared to when the object is outside of the road.

In the information processing device according to the above aspect, the control unit displays the object image in a more emphasized way when the actual position of the object is in the road, as compared to when the actual position of the object is outside of the road. Thus, in the information processing device, the occupant can be strongly alerted when the actual position of the object is in the road.

In the information processing device according to the above aspect, the one or more processors may be configured to display the object image such that actual dimensions of the object are reflected.

In the information processing device according to the above aspect, the control unit displays the object image that reflects the actual dimensions of the object. Accordingly, in the information processing device, the occupant can roughly comprehend the actual dimensions of the object by viewing the display unit.

An information processing method according to a second aspect of the present disclosure includes when an object present in a direction of travel of a vehicle traveling on a road is detected; and a positional relation between the vehicle and the object is in a predetermined state, in a road image depicting the road that is displayed on a display inside the vehicle displaying an object image depicting the object at a position that reflects an actual position of the object.

According to a third aspect of the present disclosure, a non-transitory storage medium stores instructions that are executable by one or more processors and cause the one or more processors to perform the following functions, the functions including when an object present in a direction of travel of a vehicle traveling on a road is detected; and a positional relation between the vehicle and the object is in a predetermined state, displaying an object image depicting the object at a position that reflects an actual position of the object in a road image depicting the road that is displayed on a display inside the vehicle.

As described above, the present disclosure provides an information processing device, an information processing method, and a non-transitory storage medium that enable an occupant to comprehend positions of objects relative to a road on which a vehicle is traveling, by viewing an in-vehicle display.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a hardware configuration of a vehicle;

FIG. 2 is a block diagram illustrating an example of a functional configuration of the vehicle;

FIG. 3 is a first flowchart showing a flow of control processing;

FIG. 4 is a second flowchart showing a flow of control processing;

FIG. 5 is a first explanatory diagram illustrating an example of a display that is displayed on a display unit while the vehicle is traveling;

FIG. 6 is a second explanatory diagram illustrating an example of a display that is displayed on the display unit while the vehicle is traveling;

FIG. 7 is a third explanatory diagram illustrating an example of a display that is displayed on the display unit while the vehicle is traveling;

FIG. 8 is a fourth explanatory diagram illustrating an example of a display that is displayed on the display unit while the vehicle is traveling; and

FIG. 9 is a fifth explanatory diagram illustrating an example of a display that is displayed on the display unit while the vehicle is traveling.

### DETAILED DESCRIPTION OF EMBODIMENTS

### First Embodiment

First, a first embodiment of a vehicle 10 according to the present disclosure will be described. Although the vehicle 10 may be an engine vehicle, a hybrid electric vehicle, or a battery electric vehicle, the vehicle 10 is described as being an engine vehicle in the present embodiment, as an example.

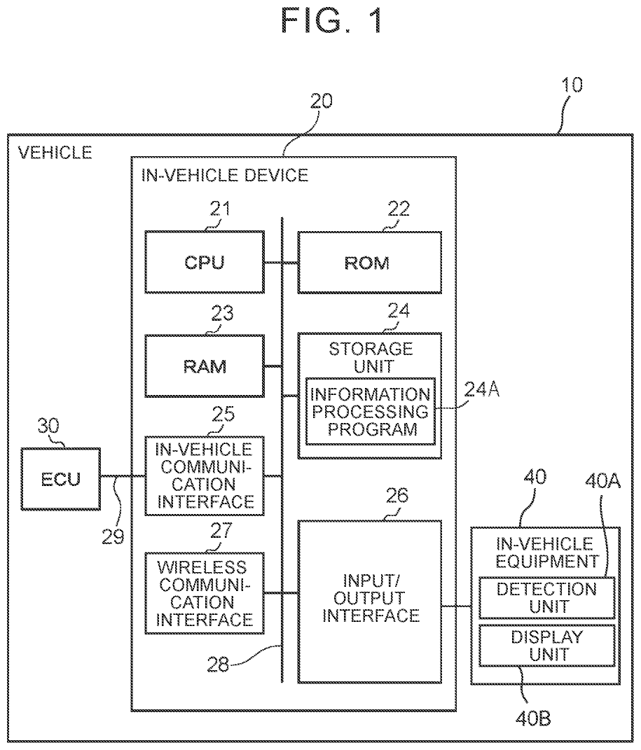

A hardware configuration of the vehicle 10 will be described. FIG. 1 is a block diagram illustrating the hardware configuration of the vehicle 10.

As illustrated in FIG. 1, the vehicle 10 includes an in-vehicle device 20, an electronic control unit (ECU) 30, and in-vehicle equipment 40. The in-vehicle device 20 is an example of “information processing device”.

The in-vehicle device 20 includes a central processing unit (CPU) 21, read-only memory (ROM) 22, random access memory (RAM) 23, a storage unit 24, an in-vehicle communication interface 25, an input/output interface 26, and a wireless communication interface 27. The CPU 21, the ROM 22, the RAM 23, the storage unit 24, the in-vehicle communication interface 25, the input/output interface 26, and the wireless communication interface 27 are communicably connected to each other via an internal bus 28.

The CPU 21 is a central processing unit that executes various types of programs and controls each unit. That is to say, the CPU 21 reads programs from the ROM 22 or the storage unit 24, and executes the programs using the RAM 23 as a work area. The CPU 21 controls each of the above configurations and executes various types of computational processing in accordance with the programs recorded in the ROM 22 or the storage unit 24.

The ROM 22 stores various types of programs and various types of data. The RAM 23 temporarily stores the programs and data, as a work area.

The storage unit 24 is made up of a storage device such as an embedded MultiMedia Card (eMMC), universal flash storage (UFS), or the like, and stores various types of programs and various types of data. The storage unit 24 stores an information processing program 24A for causing the CPU 21 to execute control processing, which will be described later.

The in-vehicle communication interface 25 is an interface for connecting to the ECU 30. This interface uses a communication standard based on a controller area network (CAN) protocol. The in-vehicle communication interface 25 is connected to an external bus 29. Although omitted from illustration, a plurality of ECUs 30 is provided for respective functions of the vehicle 10. Also, in the in-vehicle communication interface 25, the above interface is not limited to the CAN protocol, and for example, Ethernet (registered trademark) may be applied.

The input/output interface 26 is an interface for communication with the in-vehicle equipment 40 installed in the vehicle 10.

The in-vehicle equipment 40 is types of equipment installed in the vehicle 10. The vehicle 10 includes a detection unit 40A and a display unit 40B as examples of the in-vehicle equipment 40.

The detection unit 40A is a detection device that is capable of detecting a state of the vehicle 10, including inside and outside of the vehicle. The detection unit 40A includes, as an example, a camera, a vehicle speed sensor, a millimeter wave sensor, and a Global Positioning System (GPS) device.

The camera serving as the detection unit 40A is, as an example, an image-capturing apparatus that captures images using an imaging sensor such as a charge coupled device (CCD) image sensor, a complementary metal oxide semiconductor (CMOS) image sensor, or the like. The camera is provided at a front portion of the vehicle 10, and performs image capturing forward of the vehicle. The images captured by the camera are used to recognize, as an example, distance between the vehicle and a preceding vehicle traveling ahead of the vehicle, the lane, physical entities that are present ahead of the vehicle, and so forth. Images captured by the camera are stored in the storage unit 24. Note that the camera may be configured as an imaging device for other uses, such as a dashcam, an advanced driver assistance system (ADAS), and so forth. Also, the camera may be connected to the in-vehicle device 20 via the ECU 30 (e.g., camera ECU).

The vehicle speed sensor serving as the detection unit 40A is a sensor for detecting vehicle speed of the vehicle 10, and is provided, for example, in wheels of the vehicle.

The millimeter wave sensor serving as the detection unit 40A is a sensor for detecting objects present ahead of the vehicle, i.e., in a direction of travel of the vehicle 10, and is provided in at least in the front portion of the vehicle 10. The millimeter wave sensor is used to detect objects by transmitting transmission waves ahead of the vehicle 10 and receiving reflected waves from physical entities ahead. Now, objects are physical entities that may pose danger to the traveling of the vehicle 10, examples of which include pedestrians, cyclists, walls, oncoming vehicles, and so forth. Note that the physical entities that are to be recognized as such objects may be registered in advance in the vehicle 10, or may be registered by input from an occupant thereof. Also, physical entities that are to be recognized as such objects can preferably be updated, such as being deleted, newly added, or the like, either automatically by the in-vehicle device 20, or based on input from the occupant.

The GPS device serving as the detection unit 40A is a device that detects the current location of the vehicle 10. The GPS device includes an antenna that is omitted from illustration, and that receives signals from GPS satellites. Note that the GPS device may be connected to the in-vehicle device 20 via an automotive navigation system that is connected to the ECU 30 (e.g., a multimedia ECU).

The display unit 40B is an in-vehicle display for displaying action proposals relating to functions of the vehicle 10, images for describing the functions, and so forth. The display unit 40B is provided in a meter panel, as an example.

The wireless communication interface 27 is a wireless communication module for external communication. The wireless communication module uses a communication standard such as, for example, 5G, long-term evolution (LTE), Wi-Fi (registered trademark), and so forth.

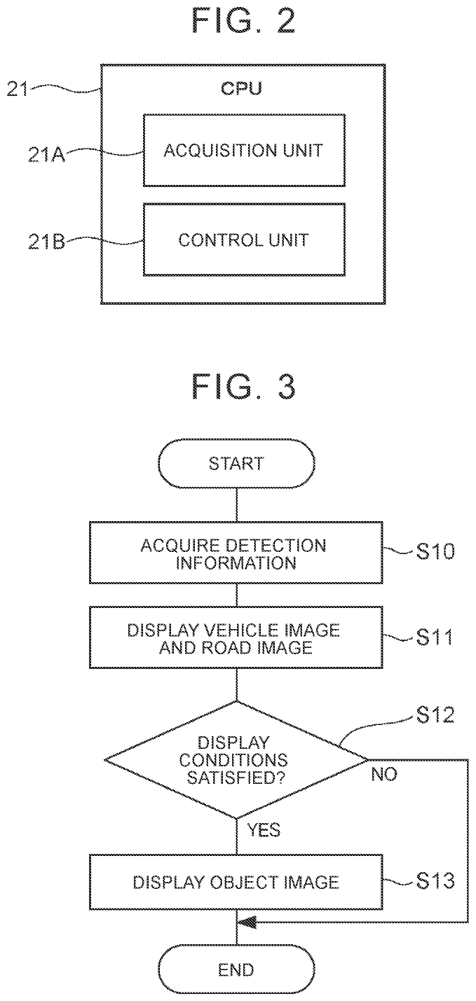

Next, a functional configuration of the vehicle 10 will be described. FIG. 2 is a block diagram illustrating an example of the functional configuration of the vehicle 10.

As illustrated in FIG. 2, the CPU 21 of the in-vehicle device 20 includes an acquisition unit 21A and a control unit 21B, as the functional configurations. The functional configurations are realized by the CPU 21 reading and executing the information processing program 24A stored in the storage unit 24.

The acquisition unit 21A periodically acquires detection information detected by the detection unit 40A, while the vehicle 10 is traveling. The detection information includes, as an example, images captured by the camera, and detection results detected by the vehicle speed sensor, the millimeter wave sensor, and the GPS device.

The control unit 21B controls display contents of the display unit 40B based on the detection information acquired by the acquisition unit 21A. For example, while the vehicle 10 is traveling, the control unit 21B can display a vehicle image 50 of the vehicle 10, a road image 52 of the road on which the vehicle 10 is traveling, and an object image 54 of an object, on the display unit 40B, based on the detection information (see FIGS. 5 to 7).

FIG. 3 is a first flowchart showing a flow of control processing in which the in-vehicle device 20 controls the display contents of the display unit 40B. The control processing is performed by the CPU 21 reading out the information processing program 24A from the storage unit 24, loading to the RAM 23, and performing execution thereof. As an example, the control processing shown in FIG. 3 is periodically executed while the vehicle 10 is traveling.

In step S10 shown in FIG. 3, the CPU 21 acquires the detection information detected by the detection unit 40A. The CPU 21 then advances to step S11.

In step S11, the CPU 21 causes the display unit 40B to display the vehicle image 50 and the road image 52, based on the detection information acquired in step S10. Specifically, the CPU 21 displays the vehicle image 50 at a position in the road image 52 that reflects the actual position of the vehicle 10. For example, when the vehicle 10 is traveling on a left side of the road, the CPU 21 displays the vehicle image 50 at a left end of the road image 52. The CPU 21 then advances to step S12.

In step S12, the CPU 21 determines whether display conditions are satisfied, based on the detection information acquired in step S10. Now, when the CPU 21 determines that the display conditions are satisfied (YES in step S12), the processing advances to step S13. On the other hand, when not determining that the display conditions are satisfied (NO in step S12), the CPU 21 ends the control processing. In the present embodiment, the CPU 21 determines that the display conditions are satisfied when an object that is present in the direction of travel of the vehicle 10 is detected by the detection unit 40A, and also a positional relation between the vehicle 10 and the object is in a predetermined state. Also, in the present embodiment, the term “when the positional relation between the vehicle 10 and the object is in a predetermined state” means when a relative collision time, which is the so-called time to collision (TTC), obtained by dividing distance to the object by relative speed between the vehicle 10 and the object, is no greater than a predetermined value. The CPU 21 calculates the TTC between the vehicle 10 and the object, using the distance and the relative speed between the vehicle 10 and the object as a detection result of the millimeter wave sensor that is the detection unit 40A.

In step S13, the CPU 21 causes the display unit 40B to display the object image 54, based on the detection information acquired in step S10. Specifically, the CPU 21 displays the object image 54 at a position in the road image 52 that reflects the actual position of the object. For example, when the actual position of the object is outside of the road, the CPU 21 displays the object image 54 at a position indicating outside of the road, in the road image 52. Thereafter, the CPU 21 ends the control processing.

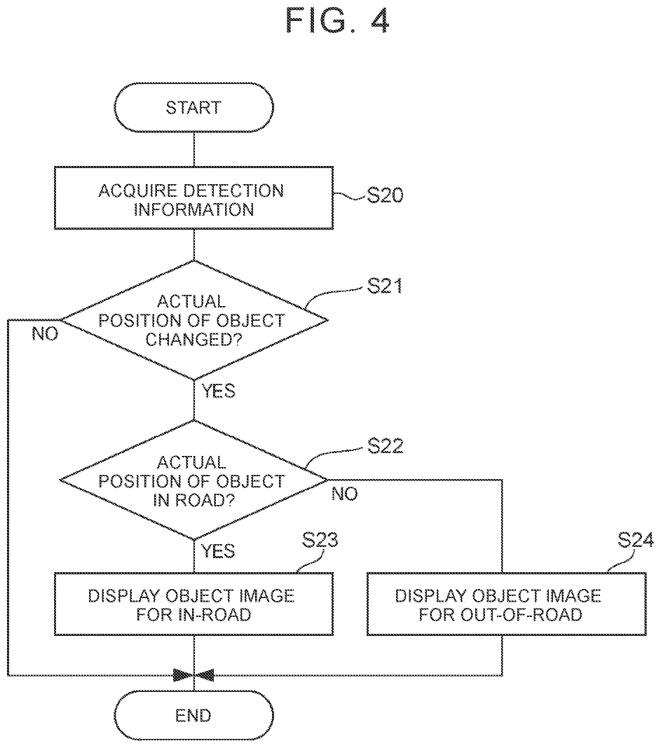

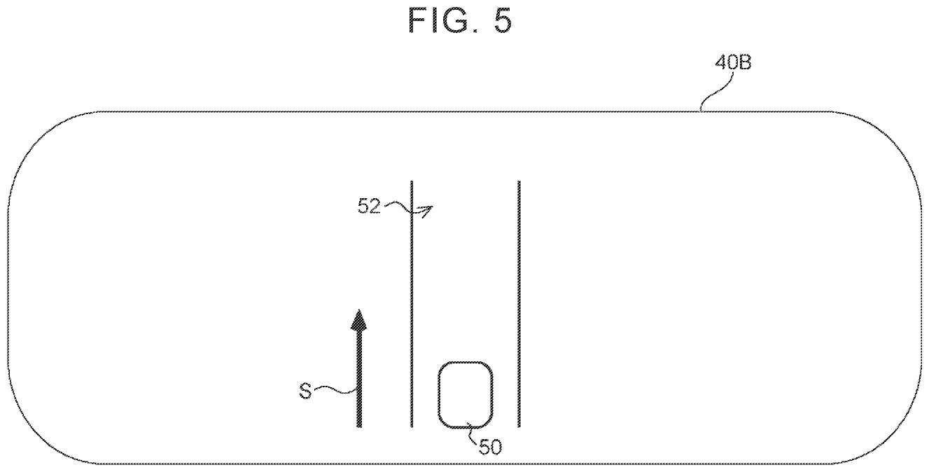

FIG. 4 is a second flowchart showing a flow of control processing. As an example, the control processing shown in FIG. 4 is periodically executed when the object image 54 is displayed on the display unit 40B.

In step S20 shown in FIG. 4, the CPU 21 acquires the detection information detected by the detection unit 40A. The CPU 21 then advances to step S21.

In step S21, the CPU 21 determines whether the actual position of the object has changed, based on the detection information acquired in step S20. Now, when determining that the actual position of the object has changed (YES in step S21), the CPU 21 advances to step S22. On the other hand, when not determining that the actual position of the object has changed (NO in step S21), the CPU 21 ends the control processing. In the present embodiment, the CPU 21 compares the position of the object indicated by the detection information obtained in the control processing executed immediately before, as to the position of the object indicated by the detection information obtained in step S20, and determines whether the actual position of the object has changed.

In step S22, the CPU 21 determines whether the actual position of the object is in the road, based on the detection information acquired in step S20. Now, when determining that the actual position of the object is in the road (YES in step S22), the CPU 21 advances to step S23. On the other hand, when not determining that the actual position of the object is in the road (NO in step S22), the CPU 21 advances to step S24. In the present embodiment, the CPU 21 uses known image recognition technology to determine whether the actual position of the object is in the road, from the detection information acquired in step S20.

In step S23, the CPU 21 causes the display unit 40B to display the object image 54 for in-road, based on the detection information acquired in step S20. Specifically, the CPU 21 displays the object image 54 for in-road, at a position that reflects the actual position of the object in the road image 52. Thereafter, the CPU 21 ends the control processing.

In step S24, the CPU 21 causes the display unit 40B to display the object image 54 for out-of-road, based on the detection information acquired in step S20. Specifically, the CPU 21 displays the object image 54 for out-of-road, at a position that reflects the actual position of the object in the road image 52. Thereafter, the CPU 21 ends the control processing.

The CPU 21 changes contents of the object image 54 depending on whether the actual position of the object is outside of the road or in the road, i.e., depending on whether the processing is in step S23 or in step S24, regarding which a specific example will be described later.

Next, an example of a display displayed on the display unit 40B as a result of the control processing shown in FIG. 3 or 4 being performed by the in-vehicle device 20 will be described.

FIG. 5 is a first explanatory diagram illustrating an example of a display that is displayed on the display unit 40B while the vehicle 10 is traveling. Specifically, FIG. 5 is an example of a display on the display unit 40B when the vehicle 10 is traveling on a straight road.

The display unit 40B illustrated in FIG. 5 displays the vehicle image 50 depicting the vehicle 10 traveling in a direction of an arrow S, and the road image 52 depicting the straight road on which the vehicle 10 is traveling. As an example, the vehicle image 50 is a substantially rectangular shape. Also, in the road image 52, an area between two straight lines is in the road, and outside of the two straight lines is outside of the road.

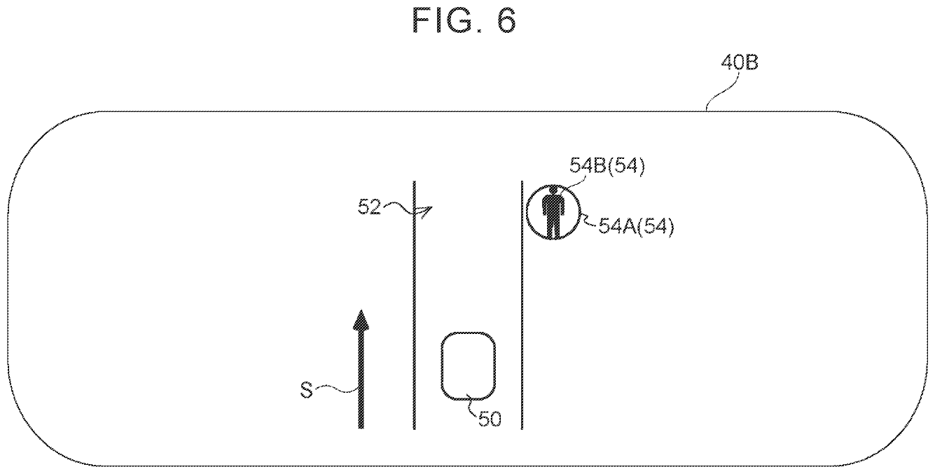

FIG. 6 is a second explanatory diagram illustrating an example of a display that is displayed on the display unit 40B while the vehicle 10 is traveling. Specifically, FIG. 6 is an example of a display on the display unit 40B following a predetermined amount of time elapsing after the example of the display illustrated in FIG. 5 is displayed.

Here, the CPU 21 changes the vehicle image 50 and the road image 52 according to change in the actual position of the vehicle 10. Accordingly, in FIG. 6, the position of the vehicle image 50 changes upward in the drawing, from that in FIG. 5, due to the vehicle 10 traveling straight on the straight road. Also, although omitted from illustration, when the vehicle 10 enters a curved road from a straight road, the CPU 21 changes the two straight lines of the road image 52 into two curved lines.

Furthermore, the display unit 40B illustrated in FIG. 6 displays the object image 54 in addition to the vehicle image 50 and the road image 52, due to the CPU 21 determining that the display conditions are satisfied. The object image 54 is displayed outside the road, on a right side of the drawing with respect to the vehicle image 50, on the forward side in the direction of travel of the vehicle 10, reflecting the actual position of the object.

As an example, the object image 54 is made up of a frame 54A that is circular, and an icon 54B that is displayed within the frame 54A and indicates the type of the object. In the present embodiment, a plurality of types of icons 54B are provided, and the icon 54B selected by the CPU 21 based on the acquired detection information is displayed within the frame 54A. In FIG. 6, an icon 54B depicting a pedestrian is displayed.

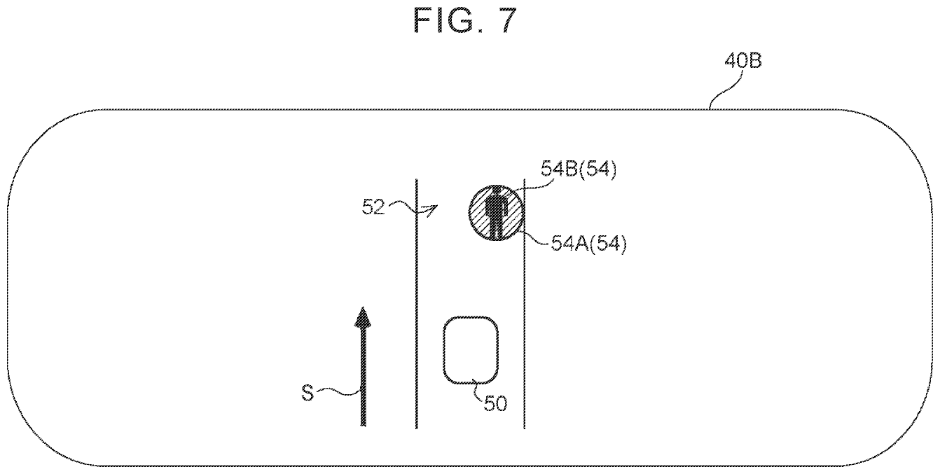

FIG. 7 is a third explanatory diagram illustrating an example of a display that is displayed on the display unit 40B while the vehicle 10 is traveling. Specifically, FIG. 7 is an example of a display on the display unit 40B following a predetermined amount of time elapsing after the example of the display illustrated in FIG. 6 is displayed.

Here, the CPU 21 changes the position of the object image 54, according to change in the actual position of the object. Thus, in FIG. 7, as the object attempts to cross the road, the position of the object image 54 changes toward the left side in the drawing, from that in FIG. 6, and the object image 54 is thus present in the road depicted by the road image 52.

Further, the CPU 21 changes the contents of the object image 54 depending on whether the actual position of the object is outside of the road or in the road. Specifically, the CPU 21 displays the object image 54 in an emphasized form when the actual position of the object is in the road, as compared to when the object is outside of the road. In the present embodiment, as an example of emphasized display, hatching is applied within the frame 54A of the object image 54 when the actual position of the object is in the road, unlike when the object is outside of the road (see FIGS. 6 and 7).

Note that although not illustrated in FIGS. 5 to 7, in addition to the vehicle image 50, the road image 52, and the object image 54, the display unit 40B is also capable of displaying other information as well, such as vehicle speed information indicating the vehicle speed of the vehicle 10, time information indicating the current time, and so forth.

As described above, when the object is detected by the detection unit 40A and the positional relation between the vehicle 10 and the object is in a predetermined state, in the in-vehicle device 20 the CPU 21 causes the object image 54 to be displayed in the road image 52 at a position that reflects the actual position of the object, as a function of the control unit 21B. Thus, in the in-vehicle device 20, the object image 54 is displayed at the position that reflects the actual position of the object in the road image 52, so that by viewing the display unit 40B, the occupant can comprehend the position of the object relative to the road on which the vehicle 10 is traveling.

Also, in the in-vehicle device 20, the CPU 21 changes the position of the object image 54, according to change in the actual position of the object, as a function of the control unit 21B. Accordingly, the in-vehicle device 20 enables the occupant to comprehend change in the actual position of the object, by viewing the display unit 40B.

Further, in the in-vehicle device 20, the CPU 21 changes the contents of the object image 54 depending on whether the actual position of the object is outside of the road or in the road, as a function of the control unit 21B. Thus, in the in-vehicle device 20, the degree of attention of the occupant to the object image 54 can be raised as compared to when the contents of the object image 54 do not change.

Also, in the in-vehicle device 20, the CPU 21 displays the object image 54 in an emphasized form when the actual position of the object is in the road, as compared to when the actual position of the object is outside of the road, as a function of the control unit 21B. Thus, the in-vehicle device 20 can strongly alert the occupant when the actual position of the object is in the road.

### Second Embodiment

Next, a second embodiment of the vehicle 10 according to the present embodiment will be described, with description of portions that are repetitive of the above embodiments omitted or simplified.

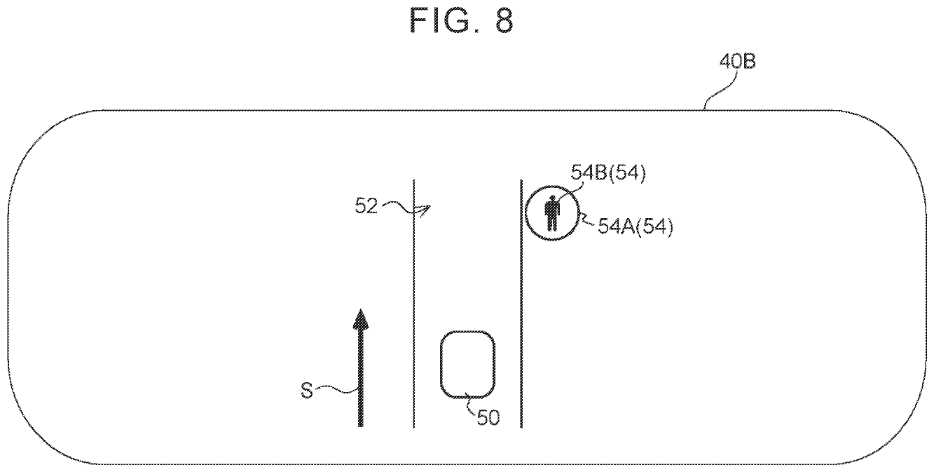

FIG. 8 is a fourth explanatory diagram illustrating an example of a display that is displayed on the display unit 40B while the vehicle 10 is traveling. Specifically, FIG. 8 is an example of a display on the display unit 40B following a predetermined amount of time elapsing after the example of the display illustrated in FIG. 5 is displayed.

The display unit 40B illustrated in FIG. 8 displays, in addition to the vehicle image 50 and the road image 52, the object image 54 outside the road, on the right side of the drawing with respect to the vehicle image 50 and on the forward side in the direction of travel of the vehicle 10, due to the CPU 21 determining that the display conditions are satisfied.

In FIG. 8, the icon 54B selected by the CPU 21 based on the acquired detection information is a child pedestrian, and the icon 54B depicting the child pedestrian is displayed within the frame 54A. Dimensions of the icon 54B depicting the child pedestrian are smaller than the dimensions of the icon 54B depicting a pedestrian (adult) in FIGS. 6 and 7.

Here, in the in-vehicle device 20, the CPU 21 displays the object image 54 that reflects the actual dimensions of the object, as a function of the control unit 21B. Specifically, the CPU 21 selects the icon 54B to be displayed on the display unit 40B, based on the dimensions of the object indicated by the acquired detection information. In the example in FIG. 8, the CPU 21 selects the icon 54B depicting a child pedestrian and displays the icon 54B on the display unit 40B, because the dimensions of the object indicated by the acquired detection information is smaller than a predetermined value. According to the above configuration, the in-vehicle device 20 enables the occupant to comprehend the actual dimensions of the object, by viewing the display unit 40B.

### Others

In the above-described embodiment, the in-vehicle device 20 is used as an example of the information processing device, but this is not restrictive, and an external device such as a server or the like that is not installed in the vehicle 10 may be an example of the information processing device, or a combination of the in-vehicle device 20 and an external device may be an example of the information processing device. For example, when the combination of the in-vehicle device 20 and an external device is an example of the information processing device, a CPU of the external device may perform at least a part of each functional configuration of the CPU 21 of the in-vehicle device 20 illustrated in FIG. 2. In this case, the control processing shown in FIG. 3 or 4 is executed by one processor of the CPU 21 of the in-vehicle device 20 or the CPU of the external device, or by a combination of a plurality of processors of the CPU 21 of the in-vehicle device 20 and the CPU of the external device.

In the above-described embodiment, the camera, the vehicle speed sensor, the millimeter wave sensor, and the GPS device are included as the detection unit 40A, but the configuration of the detection unit 40A is not limited thereto. For example, although the detection unit 40A has been described as including a millimeter wave sensor as a detection device for detecting objects present in the direction of travel of the vehicle 10, a laser imaging detection and ranging (LIDAR) device may be included, instead of or in addition to the millimeter wave sensor, and objects may be detected using the LIDAR device.

In the above-described embodiment, the display unit 40B is provided on the meter panel, but placement of the display unit 40B inside the vehicle is not limited to this. For example, the display unit 40B may be provided on an instrument panel, or configured as a head-up display (HUD) that projects an image on a display screen on the front windshield.

In the above-described embodiment, the display unit 40B has been described as being a display device provided in the vehicle 10, but this is not restrictive, and a mobile terminal such as a smartphone or the like of an occupant may be placed in the vehicle to be used as the display unit 40B.

In the above-described embodiment, a case in which the positional relation between the vehicle 10 and the object is in the predetermined state has been described as being the case in which the TTC between the vehicle 10 and the object is no greater than a predetermined value, but this is not restrictive. For example, another case, such as when the distance between the vehicle 10 and the object is no greater than a predetermined value or the like, may be the case in which the positional relation between the vehicle 10 and the object is in the predetermined state.

In the above-described embodiment, hatching is applied within the frame 54A of the object image 54 as the emphasized display, but the example of the emphasized display is not limited to this. For example, the emphasized display may include applying a specific color within the frame 54A, making a frame line of the frame 54A to flash on and off, or the like.

In the above-described embodiment, a pedestrian is has been described as an example of the icon 54B of the object image 54, but the example of the icon 54B is not limited to this.

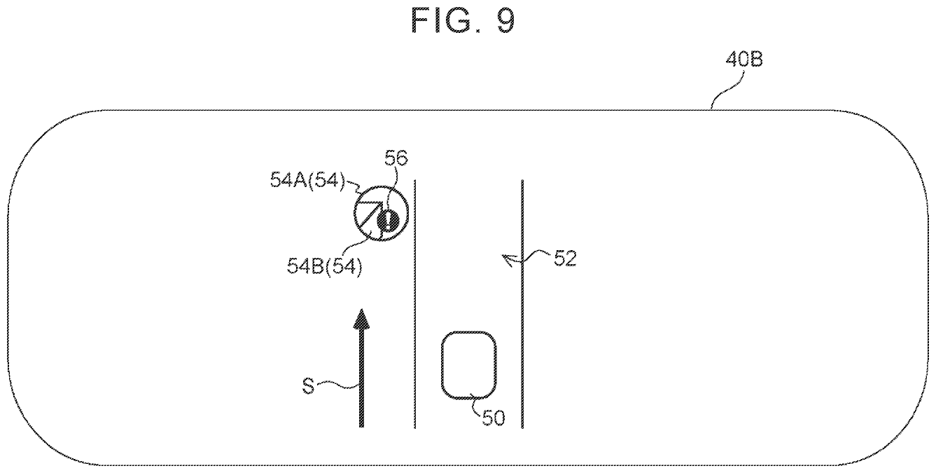

FIG. 9 is a fifth explanatory diagram illustrating an example of a display that is displayed on the display unit 40B while the vehicle 10 is traveling. Specifically, FIG. 9 is an example of a display on the display unit 40B following a predetermined amount of time elapsing after the example of the display illustrated in FIG. 5 is displayed.

The display unit 40B illustrated in FIG. 9 displays, in addition to the vehicle image 50 and the road image 52, the object image 54 outside the road, on the left side of the drawing with respect to the vehicle image 50 and on the forward side in the direction of travel of the vehicle 10, due to the CPU 21 determining that the display conditions are satisfied.

In FIG. 9, the icon 54B selected by the CPU 21 based on the acquired detection information is a wall, and the icon 54B depicting the wall is displayed within the frame 54A. As an example, in FIG. 9, no other object such as a pedestrian, a cyclist, or the like has been detected, and accordingly the icon 54B depicting such an other object is not displayed within the frame 54A. At this time, in the present embodiment, when displaying only an inanimate object such as a wall, a stopped vehicle, or the like, in the frame 54A as the icon 54B, the CPU 21 displays a caution image 56 to prompt the occupant to alertness, within the frame 54A, in addition to the icon 54B. For example, in the display unit 40B illustrated in FIG. 9, displaying the caution image 56 on the right side in the drawing of the icon 54B depicting the wall enables the occupant to be alerted of a possibility that other objects, such as pedestrians, cyclists, and so forth, may dart out from blind spots around the wall.

Note that various types of processors other than the CPU may execute the control processing carried out by the CPU 21 by reading and executing the software (program) in the above embodiment. In this case, examples of the processors include a programmable logic device (PLD) of which the circuit configuration can be changed after manufacturing, such as a field-programmable gate array (FPGA) or the like, and a dedicated electrical circuit or the like that is a processor having a circuit configuration designed exclusively to execute specific processing, such as an application-specific integrated circuit (ASIC) or the like. The control processing may also be executed by one of these various types of processors, or may be executed by a combination of two or more processors of the same type or different types (e.g., a plurality of FPGAs, a combination of a CPU and an FPGA, or the like). Also, the hardware configuration of these various types of processors is, more specifically, an electric circuit in which circuit elements such as semiconductor elements are combined.

While a form has been described in the above embodiment in which the information processing program 24A is stored (installed) in advance in the storage unit 24, this is not restrictive. The information processing program 24A may be provided in a form of being stored in a storage medium such as Compact Disk Read Only Memory (CD-ROM), Digital Versatile Disk Read Only Memory (DVD-ROM), Universal Serial Bus (USB) memory, or the like. Alternatively, the information processing program 24A may be provided in a form of being downloaded from an external device via a network.

What is claimed is:

1. An information processing device comprising one or more processors configured to, when an object present in a direction of travel of a vehicle traveling on a road is detected, and a positional relation between the vehicle and the object is in a predetermined state, in a road image depicting the road that is displayed on a display inside the vehicle, display an object image depicting the object at a position that reflects an actual position of the object.

2. The information processing device according to claim 1, wherein the one or more processors are configured to change the position of the object image, according to change in the actual position of the object.

3. The information processing device according to claim 1, wherein the one or more processors are configured to change contents of the object image depending on whether the actual position of the object is outside of the road or in the road.

4. The information processing device according to claim 1, wherein the one or more processors are configured to display the object image in a more emphasized way when the actual position of the object is in the road, as compared to when the object is outside of the road.

5. The information processing device according to claim 1, wherein the one or more processors are configured to display the object image such that actual dimensions of the object are reflected.

6. An information processing method comprising when an object present in a direction of travel of a vehicle traveling on a road is detected; and a positional relation between the vehicle and the object is in a predetermined state, in a road image depicting the road that is displayed on a display inside the vehicle, displaying an object image depicting the object at a position that reflects an actual position of the object.

7. A non-transitory storage medium storing instructions that are executable by one or more processors and cause the one or more processors to perform functions, the functions comprising when an object present in a direction of travel of a vehicle traveling on a road is detected; and a positional relation between the vehicle and the object is in a predetermined state, displaying an object image depicting the object at a position that reflects an actual position of the object in a road image depicting the road that is displayed on a display inside the vehicle.
